(19) United States
(12) Patent Application Publication
(10) Pub. No.: US 2009/0051644 A1
(43) Pub. Date: Feb. 26, 2009

(54) DISPLAY DEVICE AND RELATED POSITIONING METHOD

(76) Inventors: Po-Sheng Shih, Tao-Yuan Hsien (TW); Hsuan-Lin Pan, Tao-Yuan Hsien (TW); Po-Yang Chen, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/927,701

(22) Filed: Oct. 30, 2007

(30) Foreign Application Priority Data
Aug. 22, 2007 (TW) 096131084

(51) Int. Cl. G09G 3/36; G09G 5/00

(52) U.S. Cl. 345/104; 345/173

(57) ABSTRACT

A display device detects a touched position by making use of a inducing element and a counter electrode. The voltage produced by the counter electrode is able to affect a conductivity of the channel of the inducing element corresponding to the touched position. The inducing element and a readout circuit are disposed on a substrate of the display device. The counter electrode and a shielding element are both corresponded to the inducing element. The channel of the inducing element corresponding to the touched position changes the conductivity due to the voltage produced by the corresponding counter electrode, and an inducing signal is then generated. The inducing signal is furnished to the readout circuit for signal processing, and a readout signal is generated for analyzing the touched position.

### BACKGROUND OF THE INVENTION

1. Field of the Invention

The present invention relates to a display device and a related positioning method, and more particularly, to a liquid crystal display device and a related positioning method having input functionality.

2. Description of the Prior Art

Liquid crystal displays (LCDs) have been widely customized and become the most popular displays, because of their small size, low power consumption, and low radiation emissions. Among various types of electronic apparatuses, such as multimedia playbacks, mobile phones or personal digital assistants (PDAs), the electronic apparatus having a liquid crystal display with touch screen for performing input processes has gained popularity.

Traditionally, the prior art touch screens are primarily classified into the resistive touch screens and the capacitive touch screens. The resistive touch screen positions a touched position according to related voltage drops changing in response to the touched position. The capacitive touch screen normally comprises a plurality of sensing capacitors, and the touched position can be positioned by analyzing the changing of capacitance of the sensing capacitor corresponding to the touched position. The prior art touch screen comprises a touch panel and a liquid crystal panel separately. The touch panel and the liquid crystal panel are fabricated individually and are assembled together to form the prior touch screen. Consequently, the prior art touch screen has disadvantages such as greater weight, higher cost, and lower light penetrating rate. In order to solve the aforementioned disadvantages, a touch screen having a display device and a touch device on a single panel is developed.

### SUMMARY OF THE INVENTION

In accordance with an embodiment of the present invention, a display device having input functionality is provided. The display device comprises a substrate, a data line, an inducing element, and a shielding element. The substrate has a pixel electrode and a first conductive line. The data line is disposed on the substrate and crosses the first conductive line. The inducing element is electrically connected to the first conductive line and is disconnected with the pixel electrode. The shielding element is disposed corresponding to the inducing element.

Furthermore, the present invention provides a positioning method for a display device. The display device comprises a counter electrode, an inducing element, and a readout circuit. The positioning method comprises touching the display device in a position, changing a gap between the counter electrode and the inducing element for modulating a conductivity of the inducing element to a modulated conductivity of the inducing element corresponding to the position, generating an inducing signal based on the modulated conductivity of the inducing element, and furnishing the inducing signal to the readout circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a cross-sectional diagram schematically showing an inducing unit according to the present invention.

FIG. 2 is a cross-sectional diagram schematically showing the deformation of the counter substrate of the inducing unit in FIG. 1 when applying an external force to the counter substrate.

FIG. 3 is a circuit diagram schematically showing an array structure based on the inducing unit in FIG. 1 according to the present invention.

FIG. 4 is a layout diagram schematically showing a panel structure according to the present invention.

FIG. 5 is a schematic diagram showing a pixel unit according to the present invention.

FIG. 6 is a circuit diagram schematically showing an inducing circuit according to the present invention.

FIG. 7 is a circuit diagram schematically showing another array structure based on the inducing unit in FIG. 1 according to the present invention.

FIG. 8 is a circuit diagram schematically showing another array structure based on the inducing unit in FIG. 1 according to the present invention.

FIG. 9 is a circuit diagram schematically showing another array structure based on the inducing unit in FIG. 1 according to the present invention.

### DETAILED DESCRIPTION

Hereinafter, preferred embodiments of the present invention will be described in detail with reference to the accompanying drawings. Here, it is to be noted that the present invention is not limited thereto. Furthermore, the step serial numbers concerning the positioning method are not meant thereto limit the operating sequence, and any rearrangement of the operating sequence for achieving same functionality is still within the spirit and scope of the invention.

Please refer to FIG. 1, which is a cross-sectional diagram schematically showing an inducing unit 300 according to the present invention. The inducing unit 300 comprises an inducing element 520, a shielding element 380, a counter electrode 390, a color element CF, and a liquid crystal layer 305. The inducing element 520 is disposed on a substrate 301. The shielding element 380, the color element CF, and the counter electrode 390 are disposed on a counter substrate 302 facing to the substrate 301. There is a gap having a first spacing d1 between the counter electrode 390 and the inducing element 520. The structure of the inducing element 520 comprises a gate G, a gate-insulating layer 312, a channel 315, a high doping region 316, a source S, a drain D, and a passivation layer 360. The inducing element 520 can be a PMOS transistor, an NMOS transistor, a diode, or a thin film transistor. The channel 315 can be an amorphous-silicon semiconductor layer. The high doping region 316 can be an amorphous-silicon semiconductor region highly doped with N-type impurity. The shielding element 380 is a metal or non-metal layer having feature of light absorption or reflection.

The conductivity of the channel 315 is increasing or decreasing in response to the gate voltage of the gate G and the counter voltage of the counter electrode 390. Without any external force applied to the counter substrate 302, the first spacing d1 of the gap is unchanged. Therefore, the conductivity of the channel 315 is controlled only by the gate voltage of the gate G, and is almost not affected by the counter voltage of the counter electrode 390. Meanwhile, a background signal can be generated based on the conductivity of the channel 315 before applying any external force to the counter substrate 302. The shielding element 380 is utilized to prevent the channel 315 from being influenced by ambient light. The shielding element 380 is an optional element and is not a must.

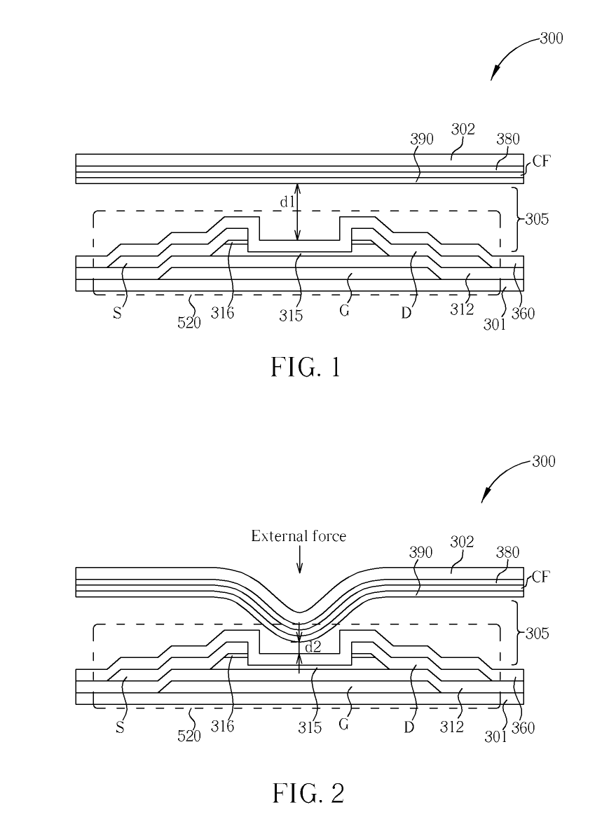

Please refer to FIG. 2, which is a cross-sectional diagram schematically showing the deformation of the counter substrate 302 of the inducing unit 300 in FIG. 1 when applying an external force to the counter substrate 302. The external force can be a pressing force applied by a finger or a touch pen in a touched position. As shown in FIG. 2, because of the external force, the spacing of the gap is reduced from the first spacing d1 to a second spacing d2, and the influence of the counter voltage of the counter electrode 390 on the conductivity of the channel 315 is enhanced. In other words, the influence of the electric field produced by the counter voltage on the channel 315 is dependent on the spacing of the gap, and the electric field is a function of the counter voltage, the first spacing d1, and the second spacing d2. That is, when the spacing of the gap is reduced from the first spacing d1 to a second spacing d2, the intensity of the electric field would be changed and affects the conductivity of the inducing element 520. Accordingly, the inducing element 520 is able to generate an inducing signal corresponding to the conductivity of the channel 315 in response to the external force. As a result, by way of analyzing the inducing signal or comparing the inducing signal with the background signal, the touched position can be positioned.

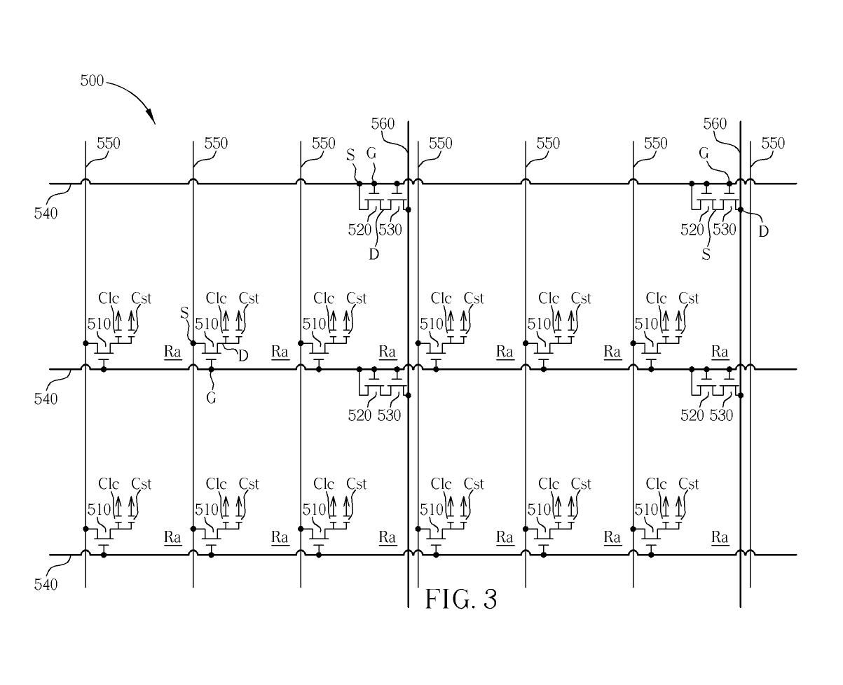

Please refer to FIG. 3, which is a circuit diagram schematically showing an array structure 500 according to the present invention. The array structure 500 comprises a plurality of gate lines 540, a plurality of data lines 550, a plurality of readout lines 560, and a plurality of pixel areas Ra. Each of the plurality of pixel areas Ra is enclosed by adjacent gate lines 540 and adjacent data lines 550 correspondingly. Each of the plurality of pixel areas Ra comprises a switching element 510, a storage capacitor Cst, a liquid crystal capacitor Clc, and a pixel electrode.

Some of the plurality of pixel areas Ra further comprises an inducing element 520 and a readout element 530. Each of the plurality of gate lines 540 is a conductive line used for conducting a gate voltage. The readout element 530 is a PMOS transistor, an NMOS transistor, a diode, or a thin film transistor. The inducing signal generated by the inducing element 520 can be transferred to the corresponding readout line 560 via the corresponding readout element 530. The gate G of a switching element 510 and the source S of a corresponding inducing element 520 in the same pixel area Ra are electrically connected to different gate lines 540 respectively.

When the gate of an inducing element 520 is furnished with a negative voltage so that the inducing element 520 is not selected to be active for inducing, the corresponding readout element 530 coupled to the inducing element 520 is utilized to filter noise generated from the inducing element 520. For instance, an undesirable inducing signal caused by ambient light may come out from the inducing element 520, and the undesirable inducing signal can be filtered by the readout element 530. Both the readout element 530 and the readout line 560 are optional elements. That is, the data line 550 may be electrically connected to the inducing element 520 directly and function to act as a readout line.

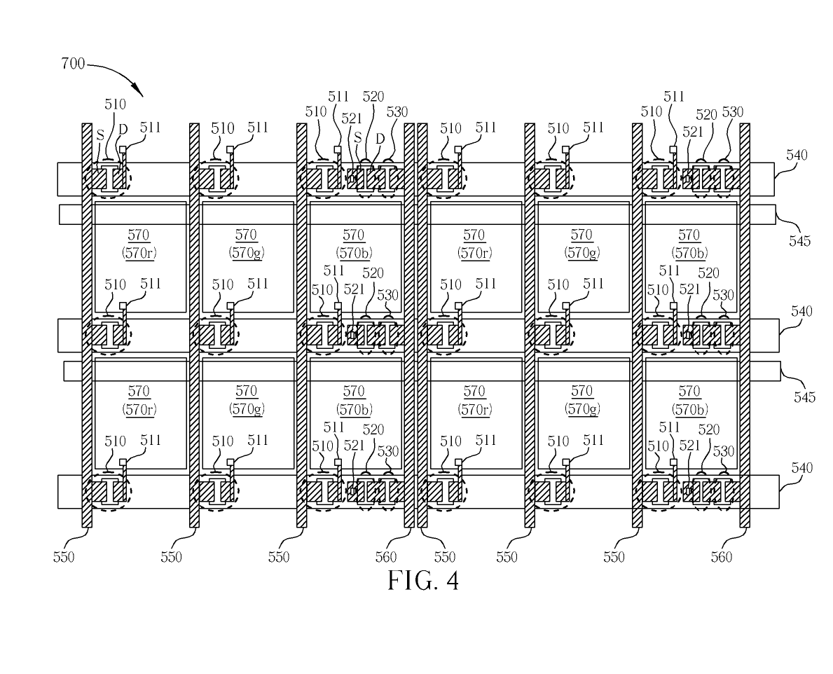

Please refer to FIG. 4, which is a layout diagram schematically showing a panel structure 700 according to the present invention. The panel structure 700 comprises a plurality of gate lines 540, a plurality of common electrode lines 545, a plurality of data lines 550, a plurality of readout lines 560, a plurality of pixel electrodes 570, a plurality of switching elements 510, a plurality of inducing elements 520, and a plurality of readout elements 530 disposed on a substrate. The panel structure 700 further comprises a plurality of color elements CF disposed on a counter substrate. The plurality of color elements CF comprises a plurality of red elements 570r, a plurality of green element 570g, and a plurality of blue elements 570b. The plurality of color elements CF may further comprise a plurality of white elements. The inducing elements 520 can be disposed on the pixel areas corresponding to individuals of the red elements 570r, the green elements 570g, the blue elements 570b, the white elements, or the composite thereof. In a preferred embodiment, the inducing elements 520 are disposed on the pixel areas corresponding to the blue elements 570b. The drain D of the switching element 510 is electrically connected to the corresponding pixel electrode 570 through a first via hole 511. The source S of the inducing element 520 is electrically connected to the corresponding gate line 540 through a second via hole 521.

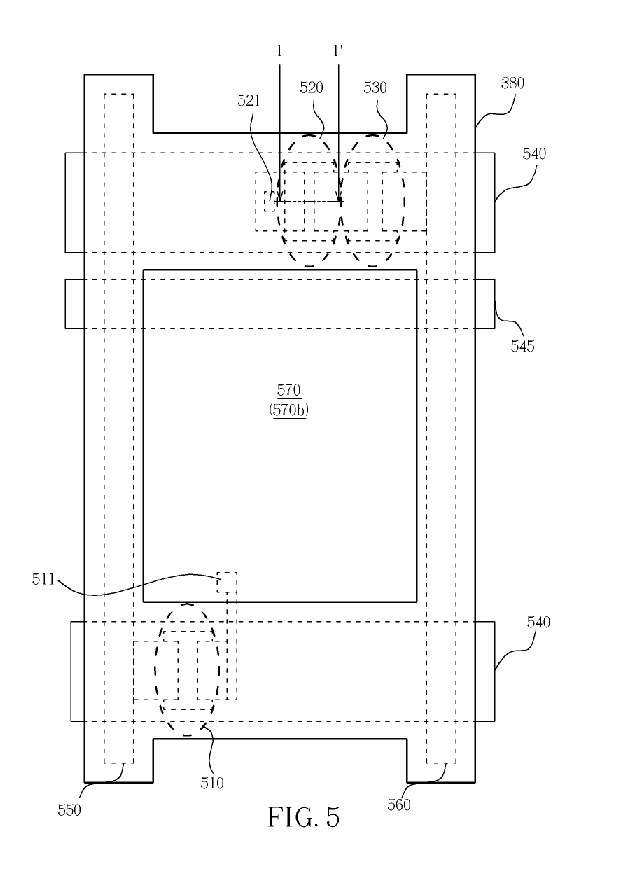

Please refer to FIG. 5, which is a schematic diagram showing a pixel unit according to the present invention. The area shielded by the shielding element 380 covers the inducing element 520, the readout element 530, and the switching element 510. The blue element 570b disposed on the counter substrate is corresponding to the pixel electrode 570 disposed on the substrate. The structure of the inducing unit 300 shown in FIG. 1 is the cross-sectional diagram taken along line 1-1′ in FIG. 5.

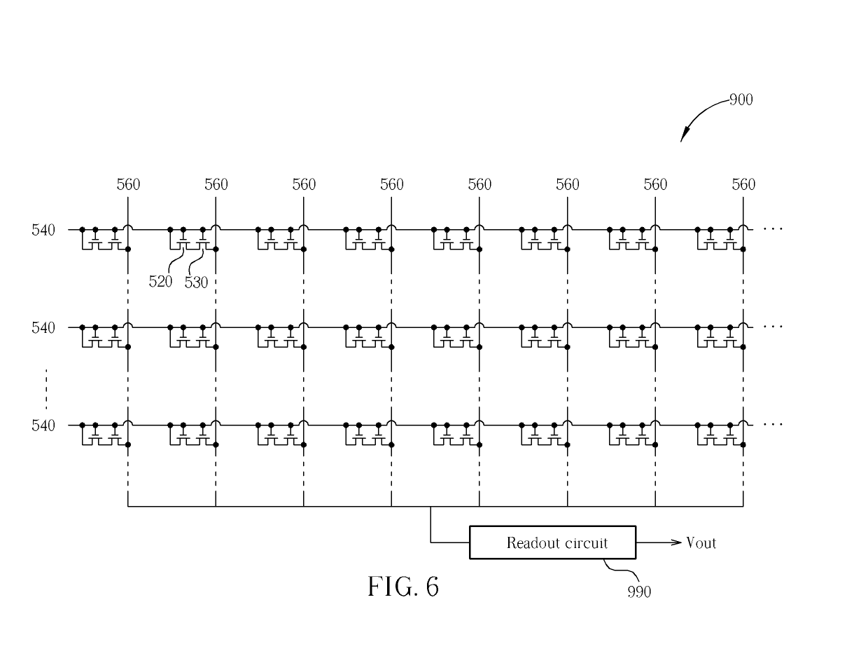

Please refer to FIG. 6, which is a circuit diagram schematically showing an inducing circuit 900 according to the present invention. Please note that some elements of the circuit such as the data lines, common electrode lines, switching elements, and pixel electrodes are omitted in FIG. 6 for the sake of demonstrating the inducing circuit 900 clearly. The inducing circuit 900 comprises a plurality of inducing elements 520, a plurality of readout elements 530, a plurality of gate lines 540, a plurality of readout lines 560, and a readout circuit 990.

The inducing element 520 and the readout element 530 are not necessary to be disposed for each of the plurality of gate lines 540. That is, the inducing element 520 and the readout element 530 can be disposed to the gate lines separated by at least one gate line without the inducing element 520 and the readout element 530 disposed. The readout circuit 990 can be electrically connected to at least one readout line. For instance, the readout circuit 990 in FIG. 6 is electrically connected to eight readout lines 560, and the inducing signals furnished to the readout circuit 990 from the eight readout lines 560 can be converted to a readout signal Vout. The readout signal Vout is then analyzed or compared with the background signal for positioning the touched position.

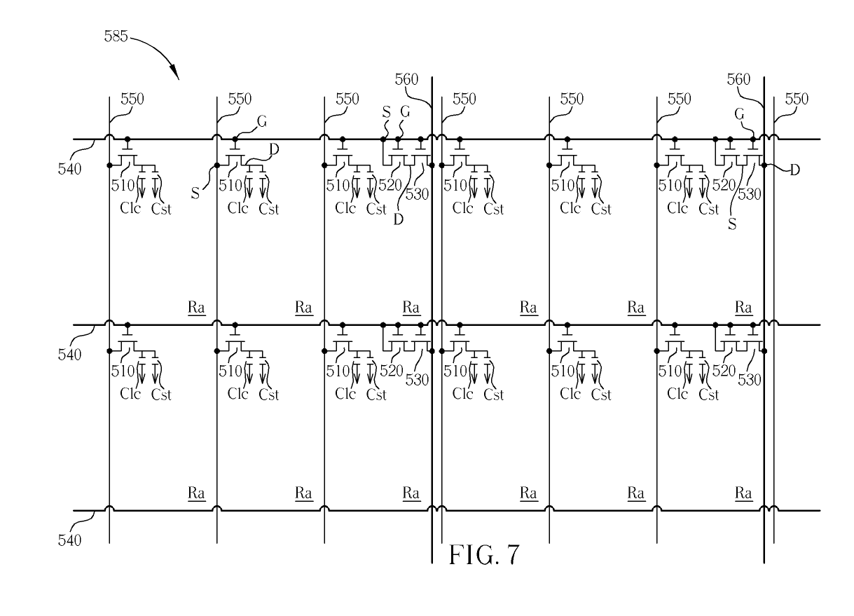

Please refer to FIG. 7, which is a circuit diagram schematically showing an array structure 585 according to the present invention. The gate G of a switching element 510 and the source S of a corresponding inducing element 520 in the same pixel area Ra are electrically connected to the same gate line 540. The other circuit connections concerning the array structure 585 is the same as the circuit connections concerning the array structure 500 shown in FIG. 3, and for the sake of brevity, further discussion on the other circuit connections concerning the array structure 585 is omitted.

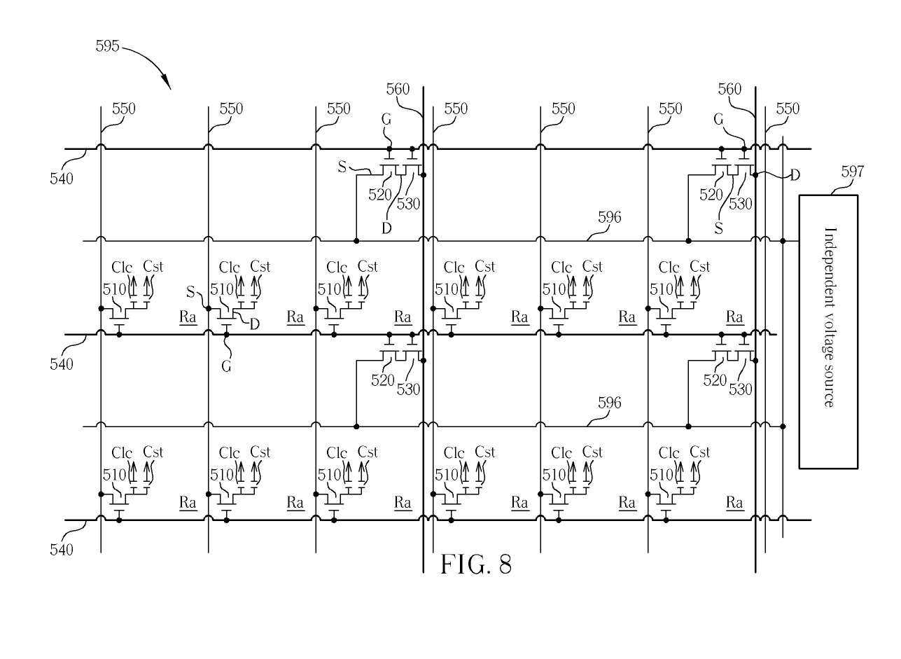

Please refer to FIG. 8, which is a circuit diagram schematically showing an array structure 595 according to the present invention. The source S of the inducing element 520 is electrically connected to an independent voltage source 597 through a corresponding power line 596. That is, the gate G and source S of the inducing element 520 in FIG. 8 are driven by a signal voltage from the gate line 540 and a power voltage from the independent voltage source 597 respectively, which means that the inducing signal can be adjusted independently.

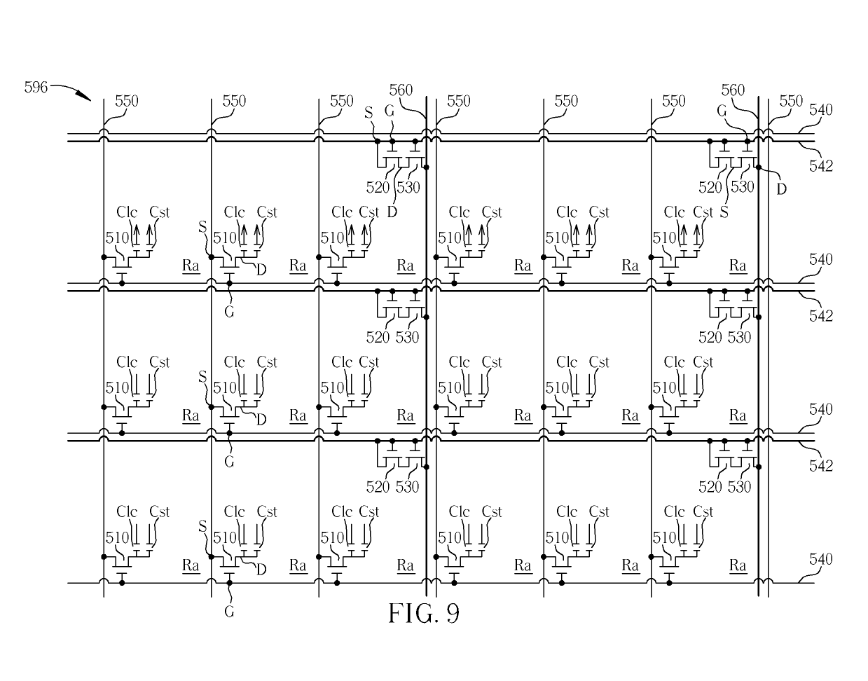

Please refer to FIG. 9, which is a circuit diagram schematically showing an array structure 596 according to the present invention. The gate G of the inducing element 520 in FIG. 9 is electrically connected to a selection line 542. The selection lines 542 are conductive lines coupled to an independent power source, so as to provide selection signals for enabling the inducing element 542 being selected for inducing.

Based on the aforementioned panel structure, a related positioning method is disclosed for a display device. The display device comprises a counter electrode, an inducing element, and a readout circuit. The positioning method comprises the following steps:

Step S10: touch the display device in a position;

Step S20: change a gap between the counter electrode and the inducing element for modulating a conductivity of the inducing element to a modulated conductivity of the inducing element corresponding to the position;

Step S30: generate an inducing signal based on the modulated conductivity of the inducing element;

Step S40: furnish the inducing signal to the readout circuit; and

Step S50: analyze the inducing signal for positioning the touched position.

The positioning method described above may comprise generating an electric field for affecting the inducing element based on a voltage of the counter electrode. The electric field is dependent on the voltage and the gap. That is, the conductivity of the inducing element corresponding to the touched position can be modulated in response to the intensity of the electric field dependent on the gap between the counter electrode and the inducing element in the touched position.

The positioning method described above may further comprise the steps of providing a shielding element to shield the inducing element from ambient light, a readout element to filter noise generated from the inducing element, and generating a background signal based on the conductivity of the inducing element prior to touching the display device in the position.

Accordingly, the step S50 may comprise comparing the inducing signal with the background signal for positioning the touched position. Besides, the step S40 may comprise furnishing the inducing signal to the readout circuit for converting the inducing signal into a readout signal, and the step S50 may comprise analyzing the readout signal or comparing the readout signal with the background signal for positioning the touched position.

Those skilled in the art will readily observe that numerous modifications and alterations of the device and method may be made while retaining the teachings of the invention.

What is claimed is:

1. A display device comprising:
a substrate comprising a pixel electrode and a first conductive line;
a data line crossing the first conductive line and disposed on the substrate;
an inducing element electrically connected to the first conductive line and disconnected with the pixel electrode; and
a shielding element corresponding to the inducing element.

2. The display device of claim 1, further comprising:
a readout circuit; and
a readout line crossing the first conductive line and electrically connected to the inducing element and the readout circuit.

3. The display device of claim 1, further comprising:
a readout element electrically connected to the inducing element.

4. The display device of claim 1, further comprising:
a switching element electrically connected to the data line, the first conductive line, and the pixel electrode.

5. The display device of claim 1, further comprising:
a readout circuit electrically connected to the data line and the inducing element.

6. The display device of claim 1, further comprising:
a counter substrate facing to the substrate; and
a counter electrode disposing between the inducing element and the counter substrate.

7. A positioning method for a display device, the display device comprising a counter electrode, an inducing element, and a readout circuit, the positioning method comprising:
touching the display device in a position;
changing a gap between the counter electrode and the inducing element;
modulating a conductivity of the inducing element to a modulated conductivity of the inducing element corresponding to the position;
generating an inducing signal based on the modulated conductivity of the inducing element; and
furnishing the inducing signal to the readout circuit.

8. The positioning method of claim 7, further comprising:
analyzing the inducing signal for positioning the position.

9. The positioning method of claim 7, further comprising:
furnishing a voltage to the counter electrode;
generating an electric field by the voltage, wherein an intensity of the electric field is dependent on the voltage and the gap; and
affecting the conductivity of the inducing element by the electric field.

10. The positioning method of claim 7, further comprising:
generating a background signal based on the conductivity of the inducting element prior to touching the display device in the position; and
comparing the inducing signal with the background signal for positioning the position.

11. The positioning method of claim 7, further comprising:
converting the inducing signal into a readout signal by the readout circuit; and
analyzing the readout signal for positioning the position.

12. The positioning method of claim 7, further comprising:
converting the inducing signal into a readout signal by the readout circuit; and
comparing the readout signal with the background signal for positioning the position.

13. The positioning method of claim 7, further comprising:
providing a readout element for filtering noise generated by the inducing element.

14. The positioning method of claim 7, further comprising:
providing a shielding element for shielding the inducing element from ambient light.
